(19) United States
(12) Patent Application Publication
(10) Pub. No.: US 2026/0073656 A1
(43) Pub. Date: Mar. 12, 2026

(54) INFORMATION PROCESSING APPARATUS, INFORMATION PROCESSING METHOD, AND STORAGE MEDIUM

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventor: Ryo KIYAMA, Koza Kanagawa (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/312,323

(22) Filed: Aug. 28, 2025

(30) Foreign Application Priority Data
Sep. 9, 2024 (JP) 2024-154932

(51) Int. Cl. G06V 10/25

(52) U.S. Cl. CPC G06V 10/25; G06V 2201/07

(57) ABSTRACT

According to one embodiment, an information processing apparatus includes a storage and a processor. The storage is configured to store an abnormality detection model generated by training using a first image captured under an environment in a normal state. The processor is configured to acquire a second image captured under the environment, calculate an abnormality score representing a degree of abnormality occurring in the environment using the abnormality detection model and generate an abnormality score map based on the calculated abnormality score, detect a first region including an object in the environment from the second image, correct the abnormality score map based on the first region, and output the corrected abnormality score map.

### CROSS-REFERENCE TO RELATED APPLICATIONS

This application is based upon and claims the benefit of priority from Japanese Patent Application No. 2024-154932, filed Sep. 9, 2024, the entire contents of which are incorporated herein by reference.

### FIELD

Embodiments described herein relate generally to an information processing apparatus, an information processing method, and a storage medium.

### BACKGROUND

In general, a predetermined environment (hereinafter, referred to as target environment) is monitored by a user visually confirming an image (video) captured by a monitoring camera installed for crime prevention or security measures.

However, there is a limit to checking a large amount of images by the user. For this reason, in recent years, it has been considered that an abnormality occurring in the target environment is automatically detected from an image captured by a monitoring camera. In this case, for example, by preparing an abnormality detection model that has been trained on an image captured under the target environment (target environment in which no abnormality occurs) in a normal state, it is possible to detect (infer) that a state has deviated from the normal state as an abnormality.

A technique using the abnormality detection model described above can detect an abnormality even if the abnormality is not defined in advance, but there is a possibility that erroneous detection occurs in a case where an object (an object having an appearance different from that of the image used for training of the abnormality detection model) not included in the image exists in the target environment or a case where the object moves in the target environment.

### BRIEF DESCRIPTION OF THE DRAWINGS

FIG. 1 is a block diagram illustrating an example of a functional configuration of an information processing apparatus according to a first embodiment;

FIG. 2 is a diagram illustrating an example of a hardware configuration of the information processing apparatus;

FIG. 3 is a diagram illustrating an example of a normal image;

FIG. 4 is a flowchart illustrating an example of a processing procedure of inference processing;

FIG. 5 is a diagram for specifically describing inference processing;

FIG. 6 is a diagram for describing a change of an object region;

FIG. 7 is a block diagram illustrating an example of a functional configuration of an information processing apparatus according to a second embodiment;

FIG. 8 is a diagram for describing teacher data;

FIG. 9 is a diagram for describing teacher data;

FIG. 10 is a diagram for describing teacher data; and

FIG. 11 is a block diagram illustrating an example of a functional configuration of an information processing apparatus according to a third embodiment.

### DETAILED DESCRIPTION

In general, according to one embodiment, an information processing apparatus includes a storage and a processor. The storage is configured to store an abnormality detection model generated by training using a first image captured under an environment in a normal state and used to calculate an abnormality score representing a degree of abnormality occurring in the environment. The processor is configured to acquire a second image captured under the environment, calculate an abnormality score representing a degree of abnormality occurring in the environment in which the acquired second image is captured using the abnormality detection model stored in the storage and generate an abnormality score map based on the calculated abnormality score, detect a first region including an object existing in the environment in which the second image is captured from the second image, correct the abnormality score map based on the detected first region, and output the corrected abnormality score map.

Various embodiments will be described with reference to the accompanying drawings.

### First Embodiment

First, a first embodiment will be described. An information processing apparatus according to the present embodiment operates as an abnormality detection apparatus for detecting an abnormality occurring in a target environment (for example, a monitoring target area) by using an image captured under the target environment.

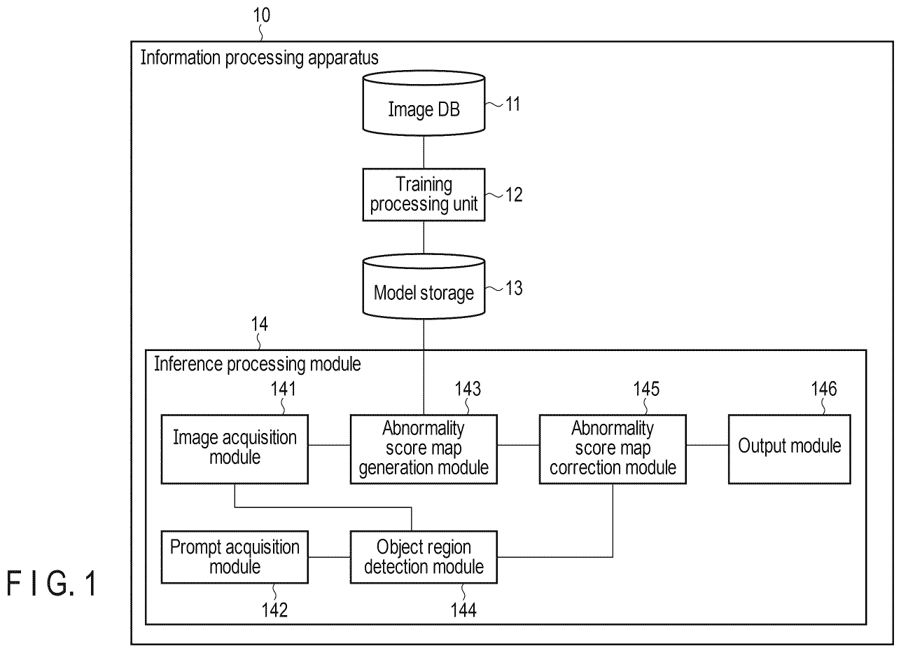

FIG. 1 is a block diagram illustrating an example of a functional configuration of an information processing apparatus according to the present embodiment. As illustrated in FIG. 1, an information processing apparatus 10 includes an image database (DB) 11, a training processing module 12, a model storage 13, and an inference processing module 14.

The image database 11 stores an image (hereinafter, referred to as a normal image) captured under a target environment in a normal state.

The training processing module 12 trains an abnormality detection model using the normal image stored in the image database 11. In other words, the abnormality detection model is generated by training on the normal image stored in the image database 11.

The abnormality detection model trained by the training processing module 12 is stored in the model storage 13. The abnormality detection model stored in the model storage 13 is used to calculate an abnormality score representing a degree of abnormality occurring in the target environment (hereinafter, referred to as an abnormality score of the target environment).

The inference processing module 14 is a functional module that executes processing corresponding to inference as to whether or not an abnormality has occurred in the target environment using the abnormality detection model, and includes an image acquisition module 141, a prompt acquisition module 142, an abnormality score map generation module 143, an object region detection module 144, an abnormality score map correction module 145, and an output module 146.

When the inference described above is performed, the image acquisition module 141 acquires an image (hereinafter, referred to as a target image) captured under the target environment. Note that the target image acquired by the image acquisition module 141 is specified by a user who uses the information processing apparatus 10, for example. Specifically, for example, when a path indicating a location where the target image is stored is specified by the user, the image acquisition module 141 can acquire (read) the target image stored in the location indicated by the path.

Note that the target image may be, for example, an image (data) captured by an imaging device such as a monitoring camera installed in the vicinity of the target environment, or may be acquired from the imaging device.

The prompt acquisition module 142 acquires a prompt indicating an object existing in the target environment. The object indicated by the prompt in the present embodiment is assumed to be, for example, an object that is not a target of abnormality detection. The prompt is, for example, a text and is specified by the user. Specifically, for example, when a path indicating a location where the prompt is stored is specified by the user, the prompt acquisition module 142 can acquire (read) the prompt stored in the location indicated by the path.

Note that the prompt may be input by the user via, for example, a graphical user interface (GUI), or may be acquired by converting a user's voice into a text by voice recognition. In the present embodiment, the prompt will be described as indicating an object, but the object in the present embodiment may be any object that can be recognized on the target image described above, and may be, for example, a fluid such as smoke or water, or a non-substance such as fire.

The abnormality score map generation module 143 calculates an abnormality score of the target environment in which the target image acquired by the image acquisition module 141 has been captured using the abnormality detection model (abnormality detection model trained by the training processing module 12) stored in the model storage 13. The abnormality score map generation module 143 generates an abnormality score map based on the abnormality score of the target environment calculated as described above. Note that the abnormality score in the present embodiment is an index related to an abnormality in which a value increases as a degree of abnormality increases.

The object region detection module 144 detects a region (hereinafter, referred to as an object region) including the object indicated by the prompt acquired by the prompt acquisition module 142 from the target image acquired by the image acquisition module 141. The object region detected by the object region detection module 144 is, for example, a rectangular region, and is represented by the center coordinates of the rectangle and the horizontal width and the vertical width of the rectangle.

Note that a shape of the object region is not limited to the rectangle. Further, the object region may be represented as segment information indicating the contour of the object or the position of the object at a pixel level, or may be represented by another method.

The abnormality score map correction module 145 corrects the abnormality score map generated by the abnormality score map generation module 143 based on the object region detected by the object region detection module 144. Note that, although details of the correction processing by the abnormality score map correction module 145 will be described later, the abnormality score map correction module 145 corrects the abnormality score map so that the object indicated by the prompt acquired by the prompt acquisition module 142 described above does not affect the detection of the abnormality in the target environment.

The output module 146 outputs the abnormality score map corrected by the abnormality score map correction module 145. Note that the abnormality score map output by the output module 146 corresponds to a detection result of an abnormality occurring in the target environment (an inference result as to whether or not an abnormality has occurred in the target environment).

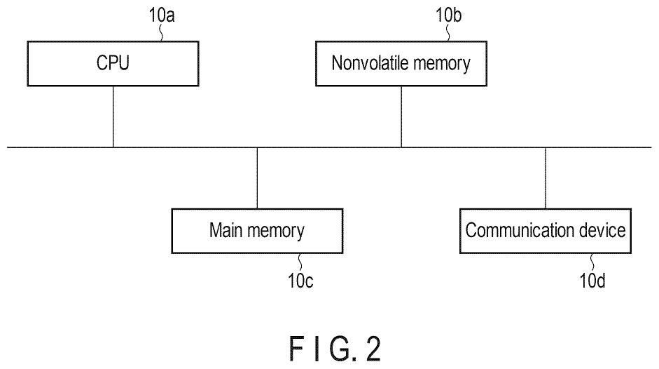

FIG. 2 illustrates an example of a hardware configuration of the information processing apparatus 10 illustrated in FIG. 1. The information processing apparatus 10 includes a CPU 10a, a nonvolatile memory 10b, a main memory 10c, a communication device 10d, and the like.

The CPU 10a is a processor for controlling operations of various components in the information processing apparatus 10. The CPU 10a may be a single processor or may include a plurality of processors. The CPU 10a executes various programs loaded from the nonvolatile memory 10b to the main memory 10c. These programs include, for example, an operating system (OS) and an application program.

The nonvolatile memory 10b is a storage medium used as an auxiliary storage device. The main memory 10c is a storage medium used as a main storage device. Although only the nonvolatile memory 10b and the main memory 10c are illustrated in FIG. 2, the information processing apparatus 10 may include other storage devices.

The communication device 10d is a device configured to perform communication with an external device (for example, a server device or the like).

In the present embodiment, the image database 11 and the model storage 13 illustrated in FIG. 1 are realized by, for example, the nonvolatile memory 10b or another storage device.

Furthermore, some or all of the training processing module 12 and the inference processing module 14 included in the information processing apparatus 10 illustrated in FIG. 1 are realized by causing the CPU 10a (that is, a computer of the information processing apparatus 10) to execute a predetermined program, that is, by software. This program may be stored in a computer-readable storage medium and distributed, or may be downloaded to the information processing apparatus 10 via a network. Note that some or all of the training processing module 12 and the inference processing module 14 may be realized by hardware such as an integrated circuit (IC), or may be realized by a combination of software and hardware.

Note that although not illustrated in FIG. 2, the information processing apparatus 10 may further include an input device such as a mouse or a keyboard, and a display device including a display and the like.

Hereinafter, the operation of the information processing apparatus 10 according to the present embodiment will be described. In the present embodiment, processing related to training of an abnormality detection model (hereinafter, referred to as training processing) and processing related to inference as to whether or not an abnormality has occurred in a target environment using the abnormality detection model (hereinafter, referred to as inference processing) are executed.

First, the above-described training processing will be briefly described. In the training processing, the training processing module 12 trains the abnormality detection model using the normal image stored in the image database 11.

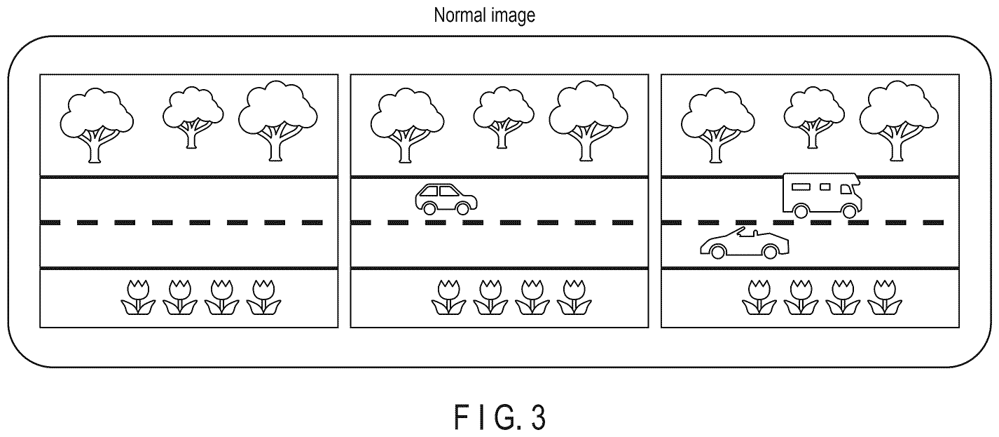

Here, for example, when an environment in which an automobile travels such as an expressway is set as the target environment, the training processing module 12 uses an image captured under the target environment as illustrated in FIG. 3 as the normal image for training. In FIG. 3, an image of an expressway on which no automobile travels, an image of an expressway on which various automobiles travel, and the like are illustrated as normal images. In a case where the environment in which the automobile travels is the target environment as described above, it is assumed that, for example, entering of a person or an animal obstructing traveling of the automobile into an expressway is detected as an abnormality occurring in the target environment.

Note that the abnormality detection model in the present embodiment is used to calculate an abnormality score of the target environment, and uses, for example, an auto encoder, a generative adversarial network (GAN), or the like, which is one of mechanisms of a neural network. In this case, the abnormality detection model learns to output an image that reproduces the image with respect to the input image, and according to such an abnormality detection model, the abnormality score of the target environment can be calculated based on a reconfiguration error between the input image and the output image.

In the present embodiment, it is assumed that the abnormality detection model is generated by training using the normal image, but an image (hereinafter, referred to as an abnormal image) captured under a target environment in an abnormal state may be further used for training of the abnormality detection model.

Furthermore, although the case where the auto encoder or the generative adversarial network is used as the abnormality detection model has been described here, the abnormality detection model may be generated according to another machine learning algorithm as long as the abnormality detection model is used to calculate an abnormality score of the target environment (generate an abnormality score map).

The abnormality detection model generated in the training processing described above is stored in the model storage 13 and used in the inference processing.

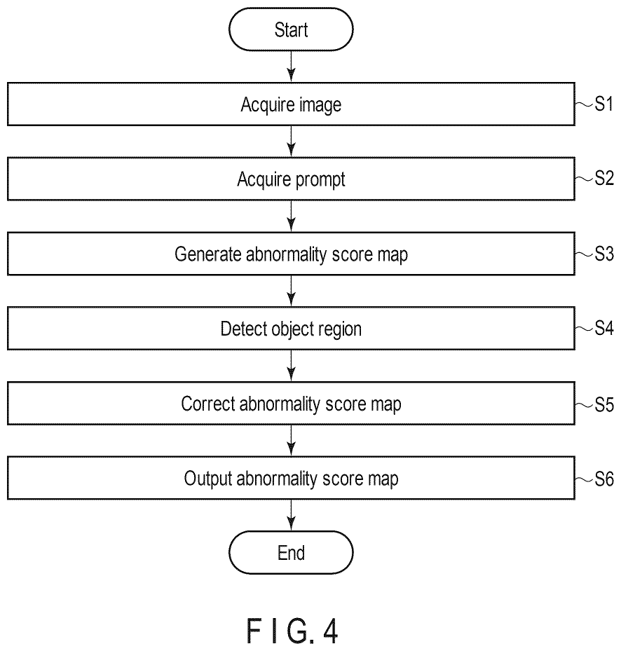

Next, an example of a processing procedure of the inference processing described above will be described with reference to a flowchart of FIG. 4.

First, the image acquisition module 141 acquires an image captured under the target environment as a target image (step S1). Note that the number of target images acquired in step S1 may be one or more.

In addition, the prompt acquisition module 142 acquires a prompt indicating an object existing in the target environment (step S2). Note that the object indicated by the prompt as described above corresponds to an object that does not need to be detected as an abnormality. The number of prompts acquired in step S2 may be one or more.

Next, the abnormality score map generation module 143 generates an abnormality score map using the abnormality detection model stored in the model storage 13 (step S3).

Here, the processing of step S3 will be described. The abnormality detection model (for example, an auto encoder) generated by the training using the normal image as illustrated in FIG. 3 is constructed so as to output an image close to the normal image when the normal image is input. In other words, when an image (for example, an abnormal image) different from the normal image is input, the abnormality detection model cannot reconfigure an image close to the image and outputs an image different from the image.

According to such an abnormality detection model, it is possible to calculate an abnormality score based on a reconfiguration error between an image (input image) input to the abnormality detection model and an image (output image) output from the abnormality detection model.

In the present embodiment, the abnormality score map generation module 143 calculates the abnormality score of the target environment based on the reconfiguration error between the target image acquired in step S1 and the image (that is, the output image of the abnormality detection model) output from the abnormality detection model by inputting the target image to the abnormality detection model. Note that, in the present embodiment, it is assumed that the abnormality score is calculated for each pixel constituting the target image. Specifically, for example, an absolute value of a difference between pixel values can be calculated for each corresponding pixel in the target image and the output image of the abnormality detection model, and the absolute value calculated for each pixel can be used as the abnormality score for the pixel.

In this case, the abnormality score map generation module 143 generates the abnormality score map by assigning the abnormality score calculated for each pixel constituting the target image to the pixel.

As described above, the abnormality score assigned to each pixel in the abnormality score map may be normalized so as to be included within a certain range. In addition, the abnormality score may be calculated by another method.

Next, the object region detection module 144 detects an object region from the target image acquired in step S1 based on the prompt acquired in step S2 (step S4). Note that, in step S4, it is assumed that the object region is detected using a base model prepared in advance by self-supervised learning using, for example, a large-scale image or text.

Note that the base model used for detecting the object region may be a single base model, or may be realized by a plurality of base models having different network configurations and parameters. Furthermore, the base model may be prepared based on other learning methods such as unsupervised learning or supervised learning instead of self-supervised learning.

Although it is assumed that the base model is constructed so as to estimate the object region in the target image by inputting the target image and the prompt, the base model may be configured to separately execute processing of extracting a region (candidate region) including a predetermined object in the target image and processing of identifying whether an object included in the estimated region is an object indicated by the prompt. That is, for example, a candidate region may be extracted from the target image by executing predetermined image processing, and the candidate region may be input to the base model (a model for identifying a label indicating the type of the object in units of images) together with the prompt to detect the object region. Further, the object region may be detected by another method different from the base model.

Next, the abnormality score map correction module 145 corrects a portion corresponding to the object region detected in step S4 included in the abnormality score map generated in step S3 (step S5).

As described above, while the abnormality score map is generated by assigning the abnormality score calculated for each pixel to the pixel, in step S5, processing of correcting the abnormality score (that is, the abnormality score of the object region) assigned to the pixel corresponding to the object region is executed. Specifically, in step S5, correction is executed to reduce the abnormality score of the object region (that is, to reduce the degree of abnormality).

When the processing of step S5 is executed, the output module 146 outputs the abnormality score map corrected in step S5 (step S6). In step S6, the abnormality score map may be output to the communication device 10d to be transmitted to, for example, a server device or the like outside the information processing apparatus 10, or may be output to a display device (display) to be presented to the user. Note that, according to the abnormality score map output in the present embodiment, it is possible to detect that an abnormality has occurred in the target environment based on the abnormality score assigned to each pixel constituting the abnormality score map as described above. Therefore, the abnormality score map corresponds to an inference result as to whether or not an abnormality has occurred in the target environment.

Note that, although it has been described here that the abnormality score map is output, the abnormality score map may be processed and output, for example. In addition, a maximum value of the abnormality score assigned to each pixel constituting the abnormality score map may be compared with a threshold (threshold for distinguishing between normality and abnormality) prepared in advance, and if the maximum value of the abnormality score is less than the threshold, it may be output (notified) that no abnormality has occurred in the target environment, and if the maximum value of the abnormality score is equal to or higher than the threshold, it may be output (notified) that an abnormality has occurred in the target environment.

Although the description has been given assuming that the object indicated by the prompt exists in the target environment (that is, the object region is detected from the target image) in FIG. 4, in a case where the object region is not detected from the target image because the object indicated by the prompt does not exist in the target environment, the processing of step S5 may be omitted, and the abnormality score map generated in step S3 may be output in step S6.

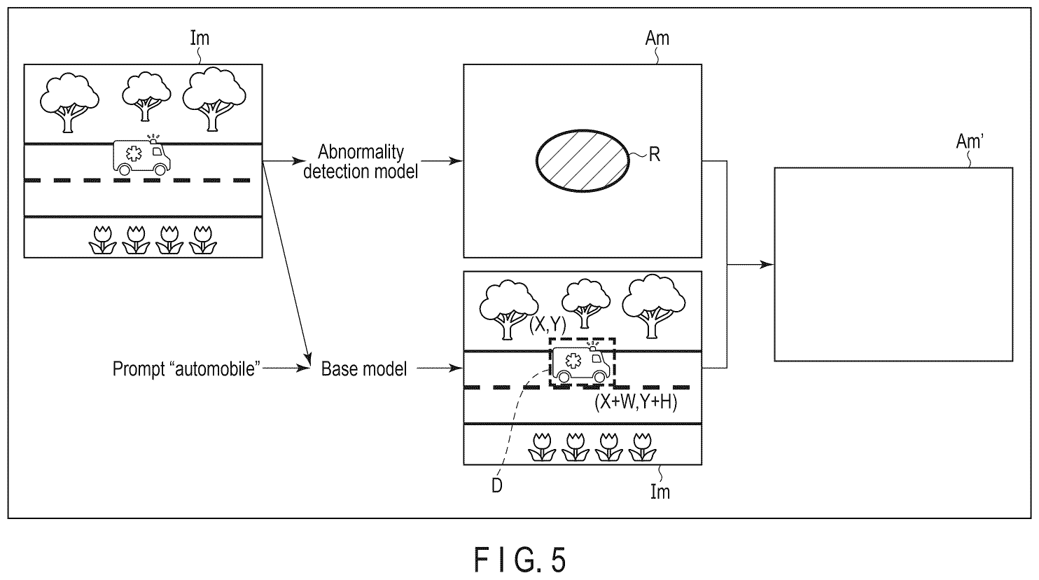

Hereinafter, the inference processing described above will be specifically described with reference to FIG. 5. Here, it is assumed that the inference processing is executed using the abnormality detection model generated by the training using the normal image illustrated in FIG. 3.

Here, as illustrated in FIG. 5, it is assumed that a target image Im captured under a target environment in which an automobile travels is acquired. In this case, the target image Im is input to the abnormality detection model to generate an abnormality score map Am.

Note that, in the present embodiment, for example, an auto encoder used as the abnormality detection model corresponds to a method of learning a normal range and estimating an outside of the range as an abnormality. However, as described above, in a case where an image in which an automobile having a position, a shape, a color, or the like different from that of the normal image is present is input as the target image Im to the abnormality detection model for which training using the normal image illustrated in FIG. 3 is performed, there is a possibility that the abnormality score map Am to which a high abnormality score has been assigned is generated. Even if a normal image similar to the target image Im is used for training of the abnormality detection model, the abnormality score assigned to the abnormality score map Am may become high in a case where the frequency at which the automobile present in the image appears in the normal image is low.

In the example illustrated in FIG. 5, it is assumed that the region where the automobile is present in the target image Im is not reconfigured in the same manner as the target image Im by the abnormality detection model (auto encoder), and the abnormality score map Am includes a region R to which a high abnormality score has been assigned.

However, in the present embodiment, for example, when it is assumed that entering of a person or an animal obstructing traveling of the automobile into an expressway (target environment) is detected as an abnormality, detecting the automobile present in the target image Im as an abnormality is erroneous detection. In other words, it is preferable to avoid detection of an abnormality based on the automobile present in the target image Im.

Therefore, in the present embodiment, as illustrated in FIG. 5, for example, by acquiring a prompt “automobile” and inputting the target image Im and the prompt “automobile” to the base model, an object region D including the automobile is detected from the target image Im. Note that, in FIG. 5, the object region D is indicated by a broken line, and is represented by, for example, the coordinates (X, Y) of an upper left point and the coordinates (X+W, Y+H) of a lower right point. In other words, the object region D is a region having a rectangular shape with a horizontal width of W and a vertical width of H. Note that the object region D may have any shape as long as it is a region including the automobile.

Next, the abnormality score map Am is partially corrected based on the position of the object region D described above. Specifically, when the abnormality score map Am is generated by assigning the absolute value of the difference between the pixel values as the abnormality score to each pixel as described above, the abnormality score assigned to each of a plurality of pixels corresponding to the object region D in the abnormality score map Am is corrected to 0.

In the present embodiment, while the automobile is an object that does not need to be detected as an abnormality, in an abnormality score map Am′, since the abnormality score of the portion corresponding to the object region D is 0 (that is, the high abnormality score calculated based on the automobile is corrected), it is possible to avoid a situation in which it is erroneously detected that an abnormality has occurred in the target environment due to the automobile included in the object region D.

Note that, although it has been described here that the correction to set the abnormality score to 0 is performed, the abnormality score (abnormality score map Am) may be corrected by another method. In the present embodiment, the abnormality score map Am may be corrected so that it is not recognized that an abnormality has occurred in the object region D, and the abnormality score assigned to each of a plurality of pixels corresponding to the object region D may be set to a score lower than at least the maximum value of the abnormality score. In this case, for example, the abnormality score assigned to each of the plurality of pixels corresponding to the object region D may be corrected to a minimum value or a median value of the abnormality score.

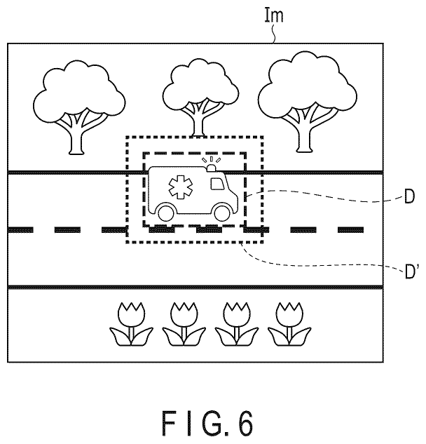

Furthermore, in the example illustrated in FIG. 5, it has been described that the object region D is detected from the target image Im, but as described above, the region where the abnormality score becomes high may be wider than the object region D. Therefore, the abnormality score map Am may be corrected by changing the detected object region D as described above. Specifically, as illustrated in FIG. 6, the object region D may be changed to a region D′ including the periphery of the object region D, and an abnormality score assigned to each of a plurality of pixels corresponding to the region D′ may be corrected. Note that the region D′ is, for example, a region obtained by adding a buffer of a fixed value to the periphery of the object region D. In addition, the buffer to be added to the periphery of the object region D may be determined (may be changed) according to a size (horizontal width W and vertical width H) of the object region D.

As described above, the information processing apparatus 10 according to the present embodiment calculates the abnormality score of the target environment in which the target image (second image) is captured (abnormality score indicating the degree of abnormality occurring in the target environment) using the abnormality detection model generated by training using the normal image (first image) captured under the target environment in the normal state, and generates the abnormality score map based on the calculated abnormality score. Further, the information processing apparatus 10 according to the present embodiment detects the object region (first region) including the object existing in the target environment in which the target image has been captured from the target image, corrects the abnormality score map based on the detected object region, and outputs the corrected abnormality score map.

In the present embodiment, with the above-described configuration, it is possible to suppress erroneous detection of an abnormality without collecting an abnormal image.

Specifically, the information processing apparatus 10 according to the present embodiment acquires, for example, a prompt indicating an object that does not need to be detected as an abnormality, and detects an object region including the object indicated by the acquired prompt from the target image. Furthermore, the information processing apparatus 10 according to the present embodiment calculates an abnormality score for each pixel constituting the target image, generates an abnormality score map by assigning the calculated abnormality score to the pixel, and corrects a first abnormality score assigned to each of a plurality of pixels corresponding to the object region detected as described above to a second abnormality score. In this case, it is assumed that the second abnormality score is, for example, a score (for example, 0) lower than a maximum value of the first abnormality score assigned to each of the plurality of pixels corresponding to at least the object region.

According to such a configuration, since it is possible to correct the abnormality score map so as to lower the abnormality score of the portion corresponding to the object region in the abnormality score map, it is possible to avoid detection (determination) that an abnormality has occurred in the target environment due to the presence of an object that does not need to be detected as an abnormality.

Note that the second abnormality score described above may be, for example, a score (for example, a minimum value, a median value, or the like) equal to or higher than the minimum value of the first abnormality score assigned to each of the plurality of pixels corresponding to the object region. According to such a configuration, when the corrected abnormality score map is displayed on the display device or the like (that is, the abnormality score map is visualized), it is possible to prevent only the abnormality score of the object region from being unnaturally viewed lower than the surroundings.

Furthermore, in the present embodiment, a weight map in which a weight for lowering the first abnormality score is assigned to each of a plurality of pixels corresponding to at least the object region may be created, and the abnormality score map may be corrected by multiplying the abnormality score map by the created weight map. In this case, for example, by creating a weight map in which the weight gradually increases from the center of the object region to the outside of the object region, it is possible to eliminate a rapid change (that is, unnaturalness when the abnormality score map is displayed) in the abnormality score at a boundary between the inside and the outside of the object region.

Furthermore, for example, unnaturalness when the abnormality score map is displayed may be eliminated by performing smoothing processing on the abnormality score after correction of the abnormality score map.

Furthermore, in the present embodiment, the abnormality score map may be corrected by changing the object region detected from the target image. In this case, the object region can be changed to, for example, a region in which a buffer is added to the periphery of the object region. Note that the buffer added to the object region may be determined according to the size of the object region. According to such a configuration, for example, even in a case where a region having a high abnormality score in the abnormality score map is wider than the object region, it is possible to appropriately correct the abnormality score map and suppress erroneous detection.

Furthermore, in the present embodiment, for example, it is assumed that the object region is detected using a base model prepared in advance by self-supervised learning, but the object region may be detected by another method. Furthermore, in the present embodiment, for example, a plurality of candidate regions (second regions) including each of a plurality of objects may be detected from the target image, and an object region may be detected by identifying whether an object included in each of the plurality of detected candidate regions is an object indicated by a prompt.

Note that, in the present embodiment, it has been described that the information processing apparatus 10 includes the image database 11, the training processing module 12, the model storage 13, and the inference processing module 14. However, the information processing apparatus 10 may be configured to include (that is, a part of the respective modules 11 to 14 is omitted) only a part of the respective modules 11 to 14. Specifically, the information processing apparatus 10 according to the present embodiment may include, for example, the inference processing module 14, and at least a part of the image database 11, the training processing module 12, and the model storage 13 may be arranged outside.

Furthermore, in the present embodiment, the information processing apparatus 10 has been described as one apparatus, but the information processing apparatus 10 may be realized as an information processing system or the like realized by a plurality of apparatuses. Specifically, for example, the information processing system may include a training processing device that executes processing corresponding to the training processing module 12 included in the information processing apparatus 10 and an inference processing device (abnormality detection device) that executes processing corresponding to the inference processing module 14 included in the information processing apparatus 10.

### Second Embodiment

Next, a second embodiment will be described. In the present embodiment, detailed description of portions similar to those of the first embodiment described above will be omitted, and portions different from those of the first embodiment will be mainly described.

Here, in the first embodiment described above, it has been described that a base model is used to detect an object region from a target image, but the base model is constructed by training using a large-scale image, the number of parameters for realizing the base model is large, and a size of the base model is also large. Such a base model can be used as long as the base model is rich in calculation resources. However, in a case where an edge device not rich in calculation resources is operated as an information processing apparatus, there is a possibility that the base model cannot be used.

Therefore, the present embodiment is different from the first embodiment described above in that an object detection model specialized for detecting an object region from an image captured under a target environment is used instead of a base model for detecting an object region at the time of inference processing.

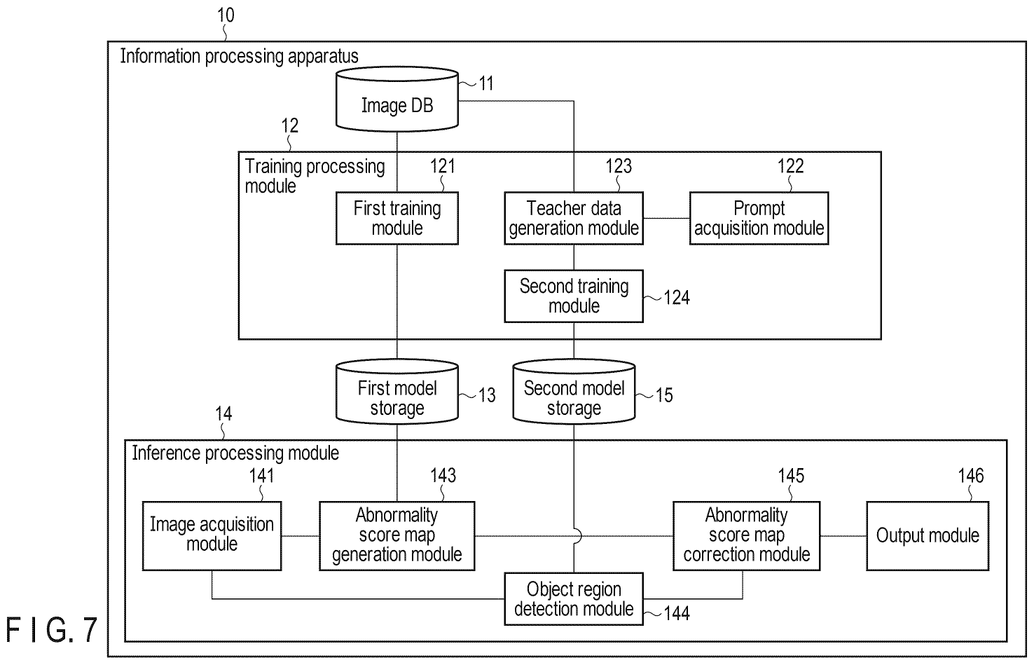

FIG. 7 is a block diagram illustrating an example of a functional configuration of an information processing apparatus according to the present embodiment. As illustrated in FIG. 7, an information processing apparatus 10 includes an image database 11, a training processing module 12, a first model storage 13, an inference processing module 14, and a second model storage 15.

Since the image database 11 is as described above with reference to FIG. 1, a detailed description thereof will be omitted.

The training processing module 12 includes a first training module 121, a prompt acquisition module 122, a teacher data generation module 123, and a second training module 124.

As described above with reference to FIG. 1, the first training module 121 trains an abnormality detection model using a normal image stored in the image database 11. The abnormality detection model trained by the first training module 121 is stored in the first model storage 13. That is, the first model storage 13 in the present embodiment corresponds to a model storage 13 described above with reference to FIG. 1.

The prompt acquisition module 122 acquires a prompt indicating an object existing in the target environment, similarly to a prompt acquisition module 142 described above with reference to FIG. 1.

The teacher data generation module 123 generates teacher data including one or more normal images stored in the image database 11 and region information indicating an object region (a region that includes the object indicated by the prompt acquired by the prompt acquisition module 122) detected from the normal images.

Note that the object region indicated by the region information included in the teacher data is detected based on, for example, the output of the base model when the normal image and the prompt acquired by the prompt acquisition module 122 are input to the base model described in the first embodiment.

Further, the region information includes, for example, information indicating a range of the object region (a position of the object or a size of the object region), and a label indicating the object included in the object region is attached.

Further, the normal image used to generate the teacher data may be the same image as the normal image used to train the abnormality detection model described above, or may be an image (normal image or abnormal image) different from the normal image used to train the abnormality detection model.

The second training module 124 trains the object detection model using the teacher data generated by the teacher data generation module 123. In a case where training is performed by the second training module 124, an object detection model constructed to output (region information indicating) an object region detected from an image captured under the target environment by inputting the image is generated. Note that the object detection model may be generated by an arbitrary method as long as the object region (object position) can be estimated from the image. The object detection model generated in this manner is stored in the second model storage 15.

The inference processing module 14 includes an image acquisition module 141, an abnormality score map generation module 143, an object region detection module 144, an abnormality score map correction module 145, and an output module 146.

Since the image acquisition module 141, the abnormality score map generation module 143, the abnormality score map correction module 145, and the output module 146 are as described above with reference to FIG. 1, a detailed description thereof will be omitted. Further, in the present embodiment, the prompt acquisition module 142 illustrated in FIG. 1 described above is omitted from the inference processing module 14.

Unlike the first embodiment described above, the object region detection module 144 according to the present embodiment detects an object region from the target image acquired by the image acquisition module 141 using the object detection model stored in the second model storage 15. As described above, in the object detection model in the present embodiment, since training is performed so as to output the object region by inputting the target image, in the present embodiment, no prompt is required at the time of inference processing.

Note that although the functional configuration of the information processing apparatus 10 according to the present embodiment has been described here, a hardware configuration of the information processing apparatus 10 is similar to that of the first embodiment described above, and thus a detailed description thereof will be omitted. In the present embodiment, the second model storage 15 illustrated in FIG. 7 is realized by, for example, a nonvolatile memory 10b or another storage device illustrated in FIG. 2 described above.

Hereinafter, training of the object detection model described above will be specifically described. First, the prompt acquisition module 122 acquires a prompt indicating an object that does not need to be detected as an abnormality. Note that, in a case where an environment in which an automobile travels such as an expressway is set as a target environment, for example, a prompt “automobile” is acquired as a prompt indicating an object that does not need to be detected as an abnormality.

Next, the teacher data generation module 123 applies one or more normal images and the prompt “automobile” stored in the image database 11 to the base model, and detects an object region including the automobile from the normal image. The teacher data generation module 123 generates teacher data based on the object region detected from the normal image.

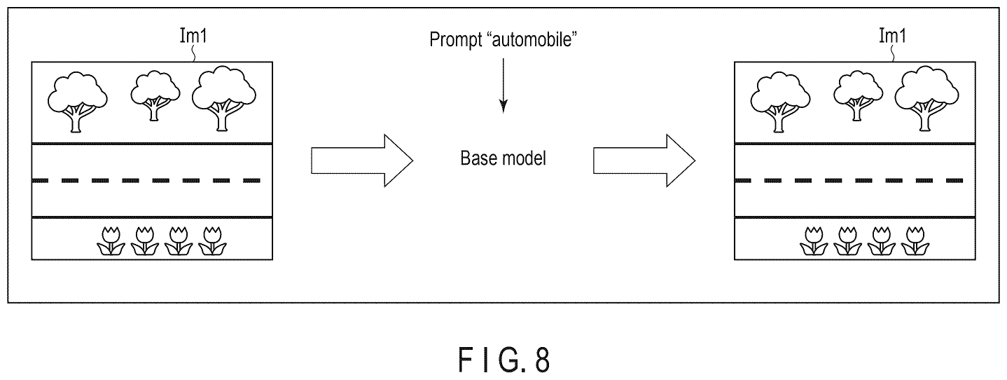

Here, for example, as illustrated in FIG. 8, when a normal image Im1 and the prompt “automobile” stored in the image database 11 are input to the base model, the object region is not detected. In this case, for example, teacher data including the normal image Im1 and information indicating that the object region does not exist in the normal image Im1 is generated.

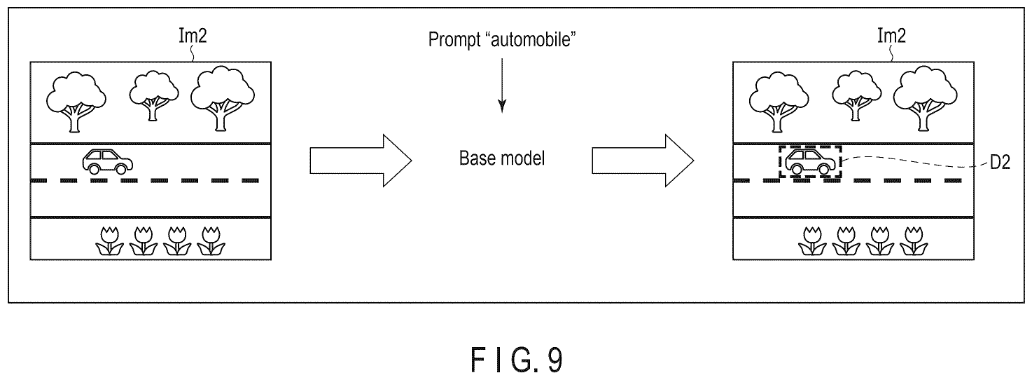

Furthermore, for example, as illustrated in FIG. 9, when a normal image Im2 stored in the image database 11 and the prompt “automobile” are input to the base model, an object region D2 is output from the base model (that is, the object region D2 is detected from the normal image Im2). In this case, for example, teacher data including the normal image Im2 and region information indicating the object region D2 is generated.

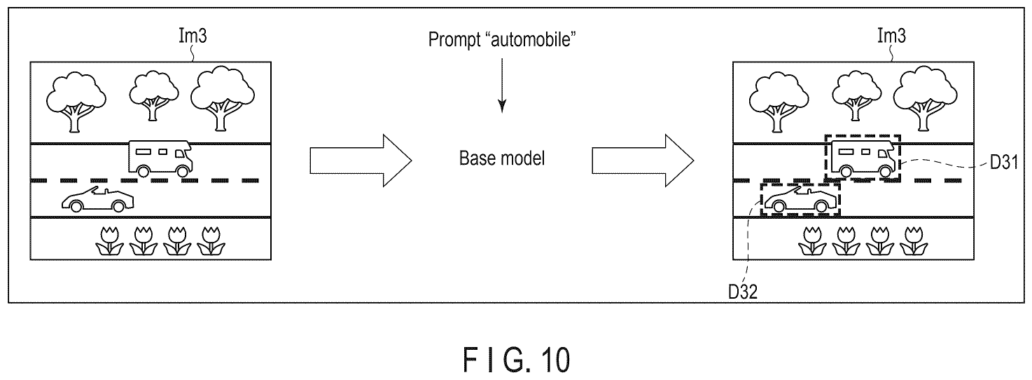

Further, for example, as illustrated in FIG. 10, when a normal image Im3 and the prompt “automobile” stored in the image database 11 are input to the base model, object regions D31 and D32 are output from the base model (that is, the object regions D31 and D32 are detected from the normal image Im3). In this case, for example, teacher data including the normal image Im3 and region information indicating the object regions D31 and D32 is generated.

The second training module 124 trains the object detection model using the teacher data generated by the teacher data generation module 123. The training of the object detection model is performed according to an arbitrary machine learning algorithm, and for example, when a normal image included in teacher data is input, processing of updating a parameter (weight) of the object detection model so that an object region indicated by region information included in the teacher data is output (detected) is executed.

Note that the inference processing in the present embodiment is similar to that of the first embodiment described above except that an object region is detected from a target image by using the object detection model described above without acquiring a prompt, and thus a detailed description thereof will be omitted.

As described above, in the present embodiment, the object detection model that has been trained on the normal image stored in the image database 11 and the teacher data including the region information indicating the object region detected from the normal image (the third region including the object indicated by the prompt) is used to detect the object region from the target image.

Here, the object detection model generated by training using the teacher data in the present embodiment is specialized in detecting the object region including the object existing in the target environment, and can be realized with a small number of parameters and a small size as compared with the base model constructed by training using the large-scale image as described in the first embodiment. In the present embodiment, by using such an object detection model at the time of inference, for example, the information processing apparatus 10 can execute inference processing by an edge device or the like having poor calculation resources.

Furthermore, in the present embodiment, it is considered that a processing amount and a processing time can be reduced as compared with the inference processing using the base model, by executing the inference processing using the object detection model.

Furthermore, in the present embodiment, with the configuration in which the object detection model is trained using the output results of the normal image and the base model as the teacher data, it is possible to prepare (generate) the object detection model without taking time and effort to generate the teacher data.

Note that, in a case where the base model is used to train the object detection model in the present embodiment, while the inference as to whether or not an abnormality has occurred in the target environment is performed by an edge device or the like that is not rich in calculation resources, the training of the object detection model may be performed by an information processing apparatus that is different from the edge device and is rich in calculation resources.

### Third Embodiment

Next, a third embodiment will be described. In the present embodiment, detailed description of portions similar to those of the first and second embodiments described above will be omitted, and portions different from those of the first and second embodiments will be mainly described.

Here, in the second embodiment described above, it is assumed that an object detection model is trained before the operation of an information processing apparatus (that is, the object detection model is generated in advance). However, for example, an image stored in an image database is not sufficient for training the object detection model, and it may be difficult to collect data (image) necessary for training the object detection model before the operation of the information processing apparatus is started.

In consideration of the above circumstances, the present embodiment is different from the second embodiment described above in that an object region is detected from a target image using a base model immediately after the operation of an information processing apparatus is started, and training of an object detection model is performed using teacher data including the target image and region information indicating the object region during the operation of the information processing apparatus.

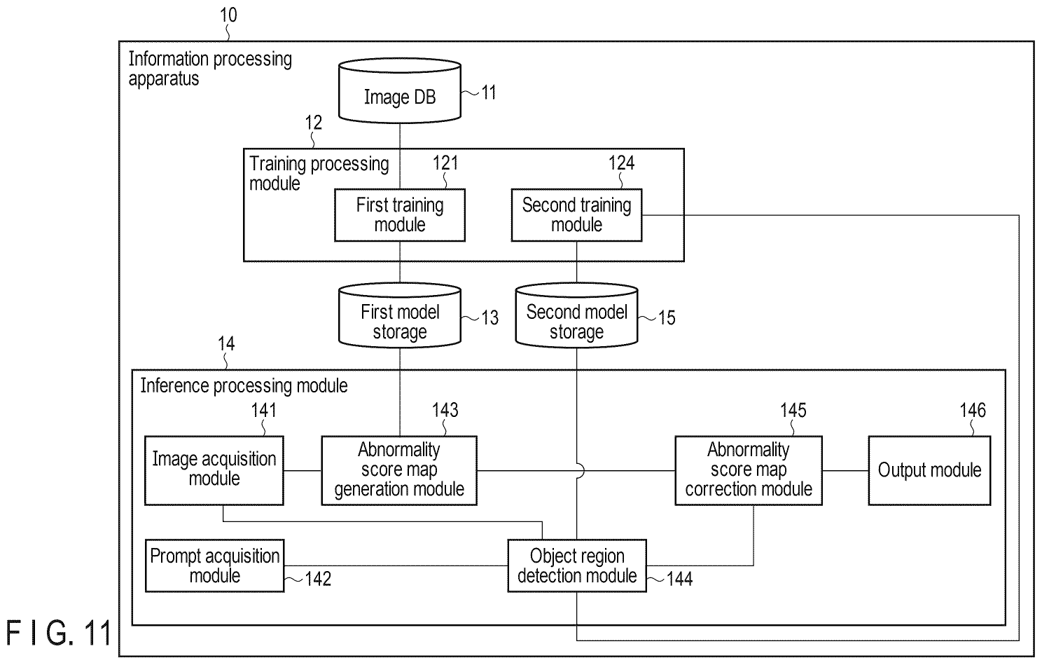

FIG. 11 is a block diagram illustrating an example of a functional configuration of the information processing apparatus according to the present embodiment. As illustrated in FIG. 11, the information processing apparatus 10 includes an image database 11, a training processing module 12, a first model storage 13, an inference processing module 14, and a second model storage 15.

Since the image database 11 is as described above with reference to FIG. 1, a detailed description thereof will be omitted.

The training processing module 12 includes a first training module 121 and a second training module 124. The first training module 121 is a functional module similar to a first training module 121 illustrated in FIG. 7 described above, and trains an abnormality detection model using a normal image stored in the image database 11. The second training module 124 is a functional module similar to a second training module 124 illustrated in FIG. 7 described above, and trains an object detection model using teacher data.

Since the first model storage 13 is as described above with reference to FIG. 7, a detailed description thereof will be omitted.

The inference processing module 14 includes an image acquisition module 141, a prompt acquisition module 142, an abnormality score map generation module 143, an object region detection module 144, an abnormality score map correction module 145, and an output module 146.

Since the image acquisition module 141, the prompt acquisition module 142, the abnormality score map generation module 143, the abnormality score map correction module 145, and the output module 146 are as described above with reference to FIG. 1, a detailed description thereof will be omitted.

During the initial operation of the information processing apparatus 10, the object region detection module 144 according to the present embodiment operates to detect the object region from the target image using the base model as described in the first embodiment. Furthermore, in a case where the object region is detected from the target image using the base model in this manner, the target image and the region information indicating the object region are transferred from the inference processing module 14 to the training processing module 12 as teacher data. The teacher data transferred from the inference processing module 14 to the training processing module 12 is used for training of the object detection model by the second training module 124 as described above.

Furthermore, in a case where training is performed by the second training module 124, an object detection model described in the second embodiment described above is generated. When the object detection model generated in this manner is stored in the second model storage 15, the object region detection module 144 operates to detect the object region from the target image using the object detection model stored in the second model storage 15.

As described above, in the present embodiment, during the initial operation of the information processing apparatus 10, the information processing apparatus 10 can train the object detection model using the target image and the detection result as teacher data while operating to detect the object region from the target image by using the base model, similarly to the first embodiment described above. As a result, when the target image is acquired (that is, the inference processing is executed) after sufficient training of the object detection model is performed, the object region can be detected from the target image using the object detection model instead of the above-described base model.

According to the above configuration, it is difficult to use the base model from the viewpoint of hardware resources (calculation resources) and an allowable inference processing time, but it is possible to implement an operation (process) of using the base model as a connection until training (generation) of the object detection model in a case where data necessary for training the object detection model cannot be collected before the operation of the information processing apparatus 10, and changing the base model to the object detection model in a case where training is performed using data collected during the operation of the information processing apparatus 10.

Note that, in the present embodiment, it has been described that the object detection model is used instead of the base model after the training of the object detection model is performed. However, for example, one of the base model and the object detection model may be selectively used based on an operation policy of the information processing apparatus 10 or the like. Furthermore, for example, whether to use the base model or the object detection model may be determined according to the training situation (for example, a training period, a training amount, or the like) of the object detection model. Whether to use the base model or the object detection model may be determined based on, for example, the detection accuracy of the object region using the object detection model.

Furthermore, in the present embodiment, it has been described that the teacher data (the target image and the region information indicating the object region detected from the target image) is transferred from the inference processing module 14 to the training processing module 12 in order to train the object detection model. However, the teacher data may be stored in, for example, a storage (not illustrated) in the training processing module 12 or the inference processing module 14, and training of the object detection model may be performed at a stage where a sufficient number of pieces of teacher data are accumulated in the storage. Note that, for example, assuming a case where estimation processing for each of a plurality of consecutive target images such as video is executed, all of the target images may be stored in the storage as teacher data, but some images (for example, an image sampled from a plurality of target images or an image acquired at regular intervals from the plurality of target images) of the plurality of target images may be stored in the storage as teacher data. According to such a configuration, for example, in a case where similar images are continuous in video, it is possible to prevent overlapping teacher data from being accumulated.

Furthermore, in the present embodiment, training of the object detection model is performed using the teacher data including the target image and the region information indicating the object region detected from the target image, but there is a case where there is an error in the region information. Specifically, the position or range of the object region indicated by the region information included in the teacher data may be deviated from the object, or the object included in the object region may be different (that is, a label indicating an object different from the object indicated by the prompt is attached to the region information) from the object indicated by the prompt. In such a case, the training of the object detection model is performed using the teacher data including the erroneous region information, and the detection accuracy of the object region by the object detection model decreases.

Therefore, although not illustrated in FIG. 11, the information processing apparatus 10 may further include a correction module. The correction module receives, for example, an instruction from the outside (for example, a user's instruction), and corrects region information (a position, a size, a label, or the like of the object region) included in the teacher data stored in the storage based on the instruction. Since the region information included in the teacher data is corrected in this manner, it is possible to train the object detection model using teacher data including correct region information. Therefore, it is possible to suppress a decrease in the detection accuracy of the object region by the object detection model (that is, the detection accuracy is improved).

According to at least one embodiment described above, it is possible to provide an information processing apparatus, an information processing method, and a program capable of suppressing erroneous detection of an abnormality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. An information processing apparatus comprising:
a storage configured to store an abnormality detection model generated by training using a first image captured under an environment in a normal state and used to calculate an abnormality score representing a degree of abnormality occurring in the environment; and
a processor configured to:
acquire a second image captured under the environment;
calculate an abnormality score representing a degree of abnormality occurring in the environment in which the acquired second image is captured using the abnormality detection model stored in the storage, and generate an abnormality score map based on the calculated abnormality score;
detect, from the second image, a first region including an object existing in the environment in which the second image is captured;
correct the abnormality score map based on the detected first region; and
output the corrected abnormality score map.

2. The information processing apparatus according to claim 1, wherein
the processor is configured to:
acquire a prompt indicating the object; and
detect, from the second image, the first region including the object indicated by the acquired prompt.

3. The information processing apparatus according to claim 2, wherein
the processor is configured to detect the first region based on an output of a base model in a case where the second image and the acquired prompt are input to the base model.

4. The information processing apparatus according to claim 3, wherein
the second image is captured in an environment in which a plurality of objects exist, and
the processor is configured to detect a plurality of second regions including each of the objects from the second image, and detect the first region by identifying whether an object included in each of the detected second regions is an object indicated by the prompt.

5. The information processing apparatus according to claim 2, wherein
the processor is configured to detect the first region from the second image by using an object detection model that has been trained using teacher data including the first image and region information indicating a third region including the object indicated by the prompt and detected from the first image.

6. The information processing apparatus according to claim 2, wherein
the processor is configured to:
train an object detection model by using teacher data including the second image and region information indicating the first region; and
detect, when the second image is acquired after the training of the object detection model is performed, the first region from the second image using the object detection model or a base model.

7. The information processing apparatus according to claim 6, wherein
the processor is configured to correct region information included in the teacher data according to an operation of a user.

8. The information processing apparatus according to claim 1, wherein
the processor is configured to:
calculate the abnormality score for each pixel constituting the second image, and generate the abnormality score map by assigning the calculated abnormality score to the pixel; and
correct a first abnormality score assigned to each of a plurality of pixels corresponding to the detected first region to a second abnormality score.

9. The information processing apparatus according to claim 8, wherein
the processor is configured to correct the abnormality score map by changing the detected first region.

10. The information processing apparatus according to claim 9, wherein
the first region is changed to a region in which a buffer is added around the first region.

11. The information processing apparatus according to claim 10, wherein
the buffer is determined according to a size of the first region.

12. The information processing apparatus according to claim 8, wherein
the second abnormality score is at least a score lower than a maximum value of the first abnormality score assigned to each of the pixels corresponding to the first region.

13. The information processing apparatus according to claim 12, wherein
the second abnormality score is a score equal to or higher than a minimum value of the first abnormality score assigned to each of the pixels corresponding to the first region.

14. The information processing apparatus according to claim 8, wherein
the abnormality score map is corrected by multiplying the abnormality score map by a weight map to which a weight for each pixel constituting the second image is assigned.

15. The information processing apparatus according to claim 14, wherein
in the weight map, a weight for reducing the first abnormality score is assigned to at least each of the pixels corresponding to the first region.

16. An information processing method executed by an information processing apparatus including a storage that stores an abnormality detection model generated by training using a first image captured under an environment in a normal state and used to calculate an abnormality score representing a degree of abnormality occurring in the environment, the information processing method comprising:
acquiring a second image captured under the environment;
calculating an abnormality score representing a degree of abnormality occurring in the environment in which the acquired second image is captured using the abnormality detection model stored in the storage, and generating an abnormality score map based on the calculated abnormality score;
detecting, from the second image, a first region including an object existing in the environment in which the second image is captured;
correcting the abnormality score map based on the detected first region; and
outputting the corrected abnormality score map.

17. A non-transitory computer-readable storage medium having stored thereon a program which is executed by a computer of an information processing apparatus including a storage that stores an abnormality detection model generated by training using a first image captured under an environment in a normal state and used to calculate an abnormality score representing a degree of abnormality occurring in the environment, the program comprising instructions capable of causing the computer to execute functions of:
acquiring a second image captured under the environment;
calculating an abnormality score representing a degree of abnormality occurring in the environment in which the acquired second image is captured using the abnormality detection model stored in the storage, and generating an abnormality score map based on the calculated abnormality score;
detecting, from the second image, a first region including an object existing in the environment in which the second image is captured;
correcting the abnormality score map based on the detected first region; and
outputting the corrected abnormality score map.
